(19) United States
(12) Patent Application Publication
(10) Pub. No.: US 2004/0001040 A1
(43) Pub. Date: Jan. 1, 2004

(54) Methods and apparatus for providing light to a display

(76) Inventors: James P. Kardach, Saratoga, CA (US); David Williams, Cheltenham (GB)

Correspondence Address: James A Flight, Grossman Flight LLC, Suite 4220, 20 North Wacker Drive, Chicago, IL, 60606, US

(21) Appl. No.: 10/185,416

(22) Filed: Jun. 28, 2002

(51) Int. Cl. G09G 3/36

(52) U.S. Cl. 345/102

(57) ABSTRACT

A low power backlight assembly for a large form factor flat screen display is disclosed which includes a modulator and a number of white light emitting diodes. The diodes are sequentially driven to provide the backlight used by the display.

### FIELD OF THE DISCLOSURE

This disclosure relates generally to backlights for flat panel displays used in computers, and, more particularly, to methods and apparatus for providing light to a flat panel display.

### BACKGROUND

Laptop and notebook computers and other portable computers (referred to herein collectively and interchangeably as “laptop computers”) typically include a microprocessor, an input device (e.g., a keyboard, a mouse, a trackball), an output device (e.g., flat screen display), random access and read-only memories, one or more mass storage devices (e.g., a floppy disk drive, a hard disk drive, an optical disk drive (e.g., a compact disk (CD) drive, a digital versatile disk (DVD) drive), a communication device (e.g., a modem, a network interface card, etc.), and a rechargeable battery.

The flat panel display, typically a thin film transistor liquid crystal display screen (TFT-LCD), operates through use of a backlight subsystem and a liquid crystal material sandwiched between polarizer filters and color filters and alignment material layers held by glass plates. The backlight subsystem is configured to provide a light source for the liquid crystal material. In response to a voltage applied to the alignment layers, molecular structural changes occur in the liquid crystals, thereby causing varying amounts of light to pass through the flat panel display.

Generally, today's backlight subsystems for large form screens (i.e., flat panel displays greater than twelve inches) utilize one or more fluorescent tubes as a light source. One type of fluorescent tube commonly used in backlight subsystems is a cold cathode fluorescent lamp (CCFL). The fluorescent tube(s) is powered, or driven, by an inverter configured to convert DC voltage, for example, 12 VDC, to an AC voltage suitable for use by the CCFL, for example, to 800 VAC.

Although the fluorescent tube(s) and inverter combination may provide an economical light source for backlighting laptop computers, their operation consumes a large portion of the overall power required to operate the laptop computer. In fact, approximately 50% of the total power required to operate a laptop computer is consumed by operation of the flat panel display; with approximately 80% of that power being consumed by the fluorescent tube and inverter combination and approximately 20% being consumed by a display controller of the flat panel display. Of course, the power consumed by the fluorescent tube and inverter combination only becomes a problem when a user is utilizing the rechargeable battery as the power source rather than commercial power provided, for example, via an AC electrical outlet. Thus, while mobility, processing capabilities, etc., of laptop computers have been optimized, they retain the disadvantage of being limited by their battery life making it desirable to reduce component power consumption without compromising mobility and processing capabilities.

### BRIEF DESCRIPTION OF THE DRAWINGS

FIG. 1 is a perspective view of an example laptop computer.

FIG. 2 is a diagram of an example flat panel display used in the laptop computer of FIG. 1.

FIG. 3 is a diagram illustrating a fluorescent light source assembly that may be used to provide backlighting to the flat panel display of FIG. 2.

FIG. 4 is a diagram illustrating operation of a fluorescent light source.

FIG. 5 is an electrical block diagram of an example backlight assembly constructed in accordance with the teachings of the invention for backlighting the flat panel display of FIG. 2.

FIG. 6 is a partial block diagram of the example backlight assembly of FIG.5.

FIG. 7 is an example modulation scheme generated by the modulation circuit of the backlight assembly of FIG. 5.

FIG. 8 is an illustration of an example component configuration for the backlight assembly of FIG. 5.

FIG. 9 is a block diagram of an example data cable configuration for the backlight assembly of FIG. 5.

### DESCRIPTION OF THE PREFERRED EXAMPLES

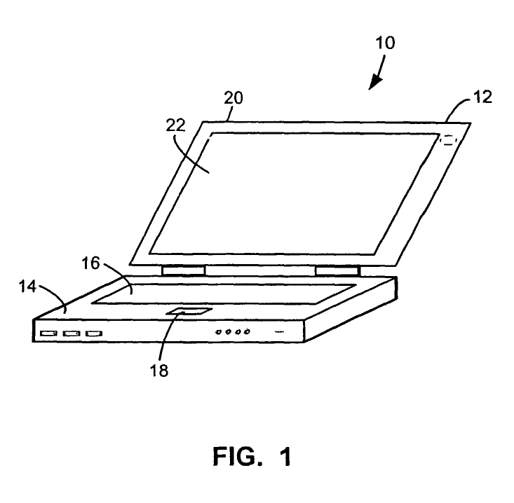

FIG. 1 is a perspective view of an example laptop computer 10. As used herein “laptop computer” refers to any computer that utilizes a large form factor display and is designed to be carried by a person. Although in the illustrated example, the laptop computer 10 is shown as including a clam-shell type housing 12 frequently associated with laptop and notebook computers, persons of ordinary skill in the art will appreciate that any other housing that is amenable to being carried by a person could alternatively be employed. For example, although the illustrated housing 12 includes (a) a base 14 containing input devices such as a keyboard 16 and touchpad 18, and (b) an upper display section 20 containing a flat panel display 22 and hinged to the base 14 for closing the housing for transport in conventional fashion, persons of ordinary skill in the art will appreciate that a one piece housing or any other type of housing utilizing a flat panel display 22 could alternatively be employed. In addition, power to the laptop computer 10 may be supplied from an external power source (e.g., a commercial power source via an AC adapter) or an internal power source (e.g., a battery).

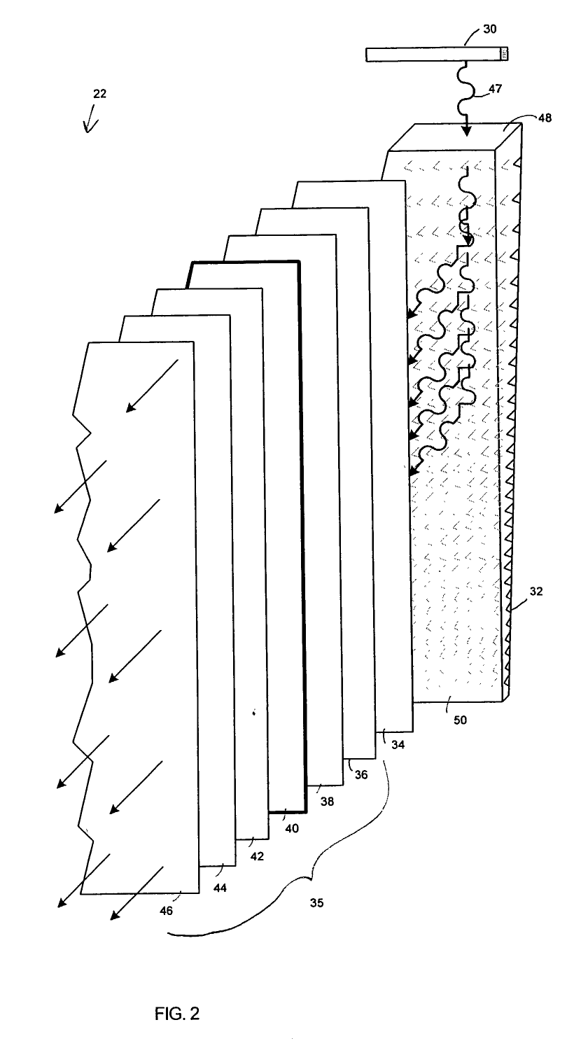

FIG. 2 is a diagram of an example flat panel display used in the laptop computer shown in FIG. 1. As used herein “flat panel display” refers to a thin film transistor liquid crystal display (TFT-LCD) screen that utilizes backlighting in conjunction with a liquid crystal display and a thin film transistor to actively control individual pixels of a pixel array. As will be appreciated by those of ordinary skill in the art, the flat panel display 22 may be configured in a number of ways including, but not limited to, a standard TFT-LCD configuration, a TN+Film configuration, an In-Plane Switching (IPS) or Super-TFT configuration, or a Multi-Domain Vertical Alignment (MVA) configuration.

The exemplary flat panel display 22 includes a light source 30, a light pipe 32, a diffusion film layer 34, and a TFT stack 35. The TFT stack 35 includes a vertical polarizer layer 36, a first glass plate 38, a liquid crystal material layer 40, a color absorbing filter layer 42, a second glass plate 44, and a horizontal polarizer layer 46. The first and second glass plates 38, 44 are configured to provide a transparent support structure for the TFT stack 35.

Light 47 generated by the light source 30 enters the light pipe 32. The light pipe 32 includes a sheet of plastic material having a thick edge 48 for receiving the light 47 and a thin edge 50. The plastic material is etched with small divets that exponentially increase in number from the thick edge 48 to the thin edge 50. The small divets operate to bend the light 47 ninety degrees towards the diffusion film layer 34. The diffusion film layer 34, typically composed of a number of sheets of films, then operates to diffuse the light 47 evenly across a surface and enhance the brightness of the light.

The diffused light then passes from the diffusion film layer 34 to the TFT stack 35. As is known, the diffused light received by the vertical polarizer layer 36, the liquid crystal material layer 40, the color absorbing filter layer 42, and the horizontal polarizer layer 46, is manipulated to allow varying amounts of light to reach the pixel array and create a particular image on the flat panel display 22. This manipulation occurs as a result of inducing structural changes in the liquid crystals by applying a voltage across the TFT stack.

Persons of ordinary skill in the art will appreciate that optimal backlighting is achieved when the “color temperature” of the light generated by the light source used in the flat panel display 22 is perceived by the human eye as good white light (e.g., matched to a Photopic curve or approximately 80-200 luminance). Therefore, in order for light generated by a light source to provide adequate backlighting, it must, among other things, traverse the many layers of flat panel display 22 from the light pipe 32 through the liquid crystal material to the horizontal polarizer layer 46, and, upon arriving on the screen side, be perceived by the human eye as good white light.

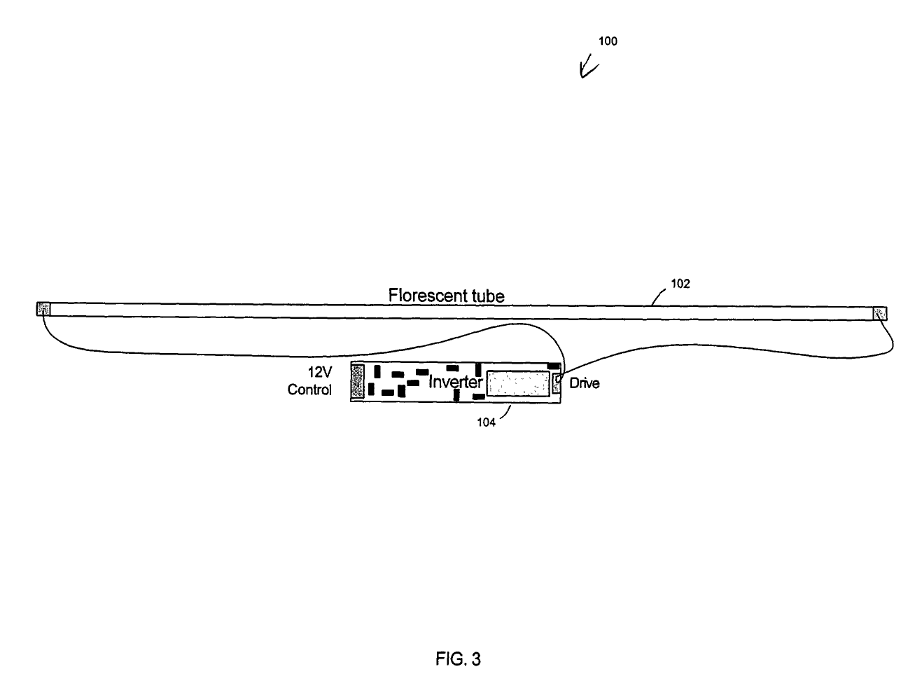

Fluorescent light is one type of light that is generally perceived by the human eye as good white light. FIG. 3 is a diagram illustrating a fluorescent light source assembly 100 that may be used to provide backlighting to the flat panel display 22. The fluorescent light source assembly 100 includes one or more cold cathode fluorescent lamp(s) (CCFL) 102, and an inverter 104. The CCFL 102 provides the light necessary to backlight the flat panel display 22. Due to space constraints imposed by the thickness of the flat panel display 22 and the notebook computer housing, the diameter of the CCFL 102 is typically less-than-or-equal-to 3 millimeters. The inverter 104 provides the power source to drive the CCFL 102. Thus, the inverter 104 is configured to convert a DC voltage, for example, 12 VDC, to an AC voltage, for example, 800-1200 VAC, required to drive the CCFL 102.

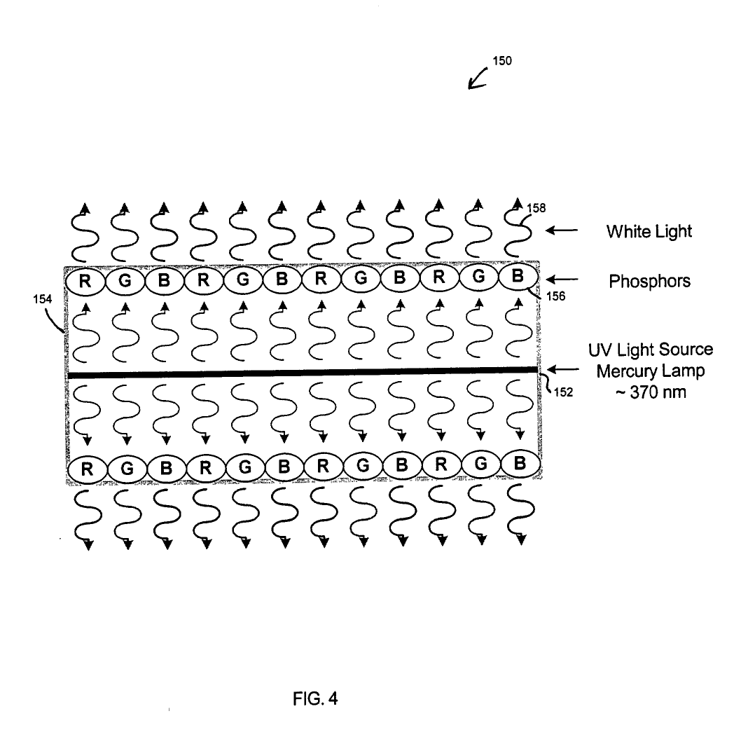

FIG. 4 is a diagram illustrating operation of a fluorescent light source such as the CCFL 102. Typically, a mercury lamp 152 comprised of mercury vapor and axially disposed in a glass tube 154, provides the initial light source. The interior wall of the glass tube 154 is coated with a phosphors compound 156. Upon application of an electrical current to the mercury lamp 152, an ultraviolet (e.g., luminous blue-green) light is generated by ionized mercury vapor. The ultraviolet light strikes the interior wall of the glass tube 154 and causes the phosphors compound 156 to emit fluorescent light 158 suitable for backlighting the flat panel display 22. The fluorescent light 158 emitted is due to the creation of red, blue, and green photons that result from an interaction between the ultraviolet light and the phosphors compound. The fluorescent light 158 appears as good white light to the naked eye due to proper balance and intensity of the red, blue and green photons.

Although the CCFL 102 and inverter 104 provide suitable backlighting capability for the flat panel display 22, they generally account for 40% of the total power consumed during operation of the laptop computer 10. For example, operation of the CCFL 102 and inverter 104 consumes approximately 3-6 watts out of a total of 7 to 14 watts required to operate the laptop computer 10, depending on the system. Thus, by reducing the power consumed by backlighting the flat panel display 22 when the laptop computer 10 is connected to the internal power source (e.g., a lithium ion rechargeable battery), significant savings in power consumption are achieved, which lengthens the possible operating time between battery charges.

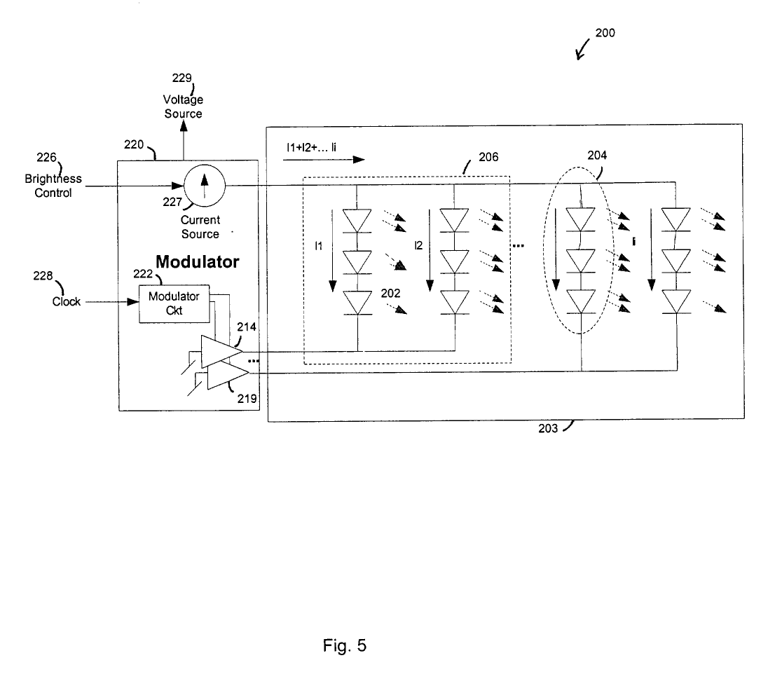

As noted above, optimal backlighting is achieved when the color temperature of light selected as a source of backlighting is perceived by the human eye as good white light. FIG. 5 is an electrical block diagram of an example backlight assembly 200 for backlighting the flat panel display 22. The backlight assembly 200 includes a number of blue light emitting diodes (LEDs) 202 coated with a phosphor compound. For example, an LED having model number E1S31-AW0C7-01, manufactured by Toyoda Gosei Co., Ltd. could be used in this role. Upon application of an electric current to the LED(s) 202, the blue light generated by the LED(s) 202 causes the phosphor compound coating to emit a light perceived as good white light by the human eye.

The power consumed by operation of the LED(s) 202 used in the backlight assembly 200 is significantly lower than the power consumed by operation of a CCFL used in a traditional flat panel display fluorescent light assembly. For example, during operation of the laptop computer 10, each of the LEDs 202 consumes approximately 50-80 milliwatts and a large form factor screen requiring thirty-six LEDs consumes approximately 1.8-2.9 watts; this power can be lowered through modulation of the LEDs 202. A CCFL used for an equivalently sized screen consumes approximately 1.5-3 watts, while the addition of an inverter boosts power consumption to 3-6 watts. In addition, the physical space required by 36 LEDs is less than, or comparable to, the space required by a typical CCFL used as a light source. Thus, the backlight assembly 200 provides a light source at a color temperature that is perceived by the human eye as good white light—and at a power lower than is required by the CCFL/inverter combination.

Exploitation of existing manufacturing and assembly processes used to build laptop computers may be achieved by physically and electrically arranging the LED(s) 202 for optimal illumination while using existing space and power constraints (e.g., existing battery voltage capability). The electrical arrangement of LED(s) 202 may be determined by (1) the voltage capability of the source voltage, (for example 12 volts (V)), and (2) the forward voltage required for each LED 202. For example, if operation of each LED 202 requires 2½ to 3½ volts, depending on the current (i.e., 5-25 milliamperes (mA)) required at a given moment, a 12 V source voltage can easily provide sufficient forward voltage (e.g., 10½ V) to three series connected LEDs requiring a 25 mA current. Thus, in the example shown in FIG. 5, the LED(s) 202 are arranged into an array of “LED strings” 204, with each LED string 204 comprising three series connected LEDs.

The number of LED strings 204 required per backlight assembly 200 is determined by a variety of factors including, inter alia, the size of the flat panel display 22 and the luminous output capability of the LED(s) selected for the backlight assembly 200. For example, experimentation indicates that twelve LED string(s) 204 having three LEDs per string provide sufficient backlighting for a 13 inch flat panel display. However, as will be appreciated by those of ordinary skill in the art, the number of LED strings 204 and the arrangement of LED(s) 202 within the LED strings 204 may vary depending on the backlighting requirements of the flat panel display 22 as well as the electrical characteristics of the LEDs.

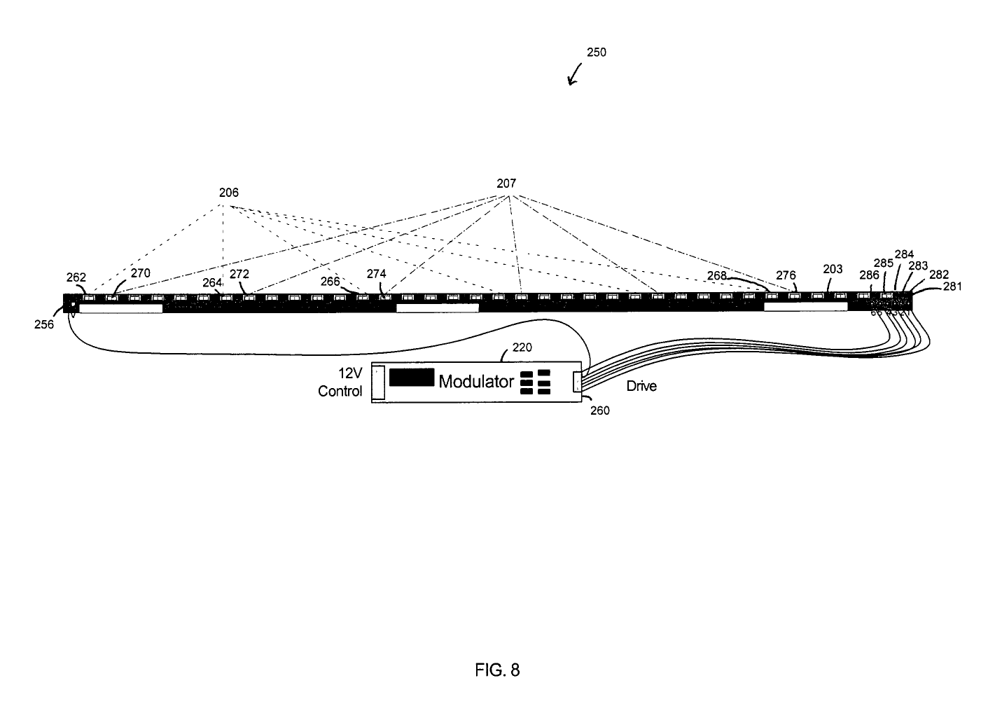

The optimum physical arrangement of LEDs may be determined by physical constraints imposed due to the size of the flat panel display and the size of the LED(s) 202. The illustrated LED array is shown as including parallel LED strings. The LED(s) 202 (which measure about 1.5 millimeters (mm) wide and about 1.4 mm tall) are physically arranged into a substantially straight line, herein referred to as an “LED stick” 203 (discussed below in connection with FIG. 8). As will be appreciated by those of ordinary skill in the art, the number and arrangement of LED(s) 202 may vary depending on the backlighting requirements of the flat panel display 22, the voltage capacity of the battery used to power the laptop computer, and the voltage requirements of the LEDs selected for the backlight assembly 200.

Because LEDs reach maximum luminous capability at their higher currents but decrease in luminosity when overheated, ensuring operation of the LED(s) 202 near their maximum luminous capability is accomplished by cycling, or modulating, power to the LED(s) 202. This allows the LED(s) 202 to operate efficiently by remaining “on” and illuminating for a preselected time period when a current is applied, and by remaining “off” and, therefore, not illuminating (and, thus, cooling) for another predetermined time period when the current is removed.

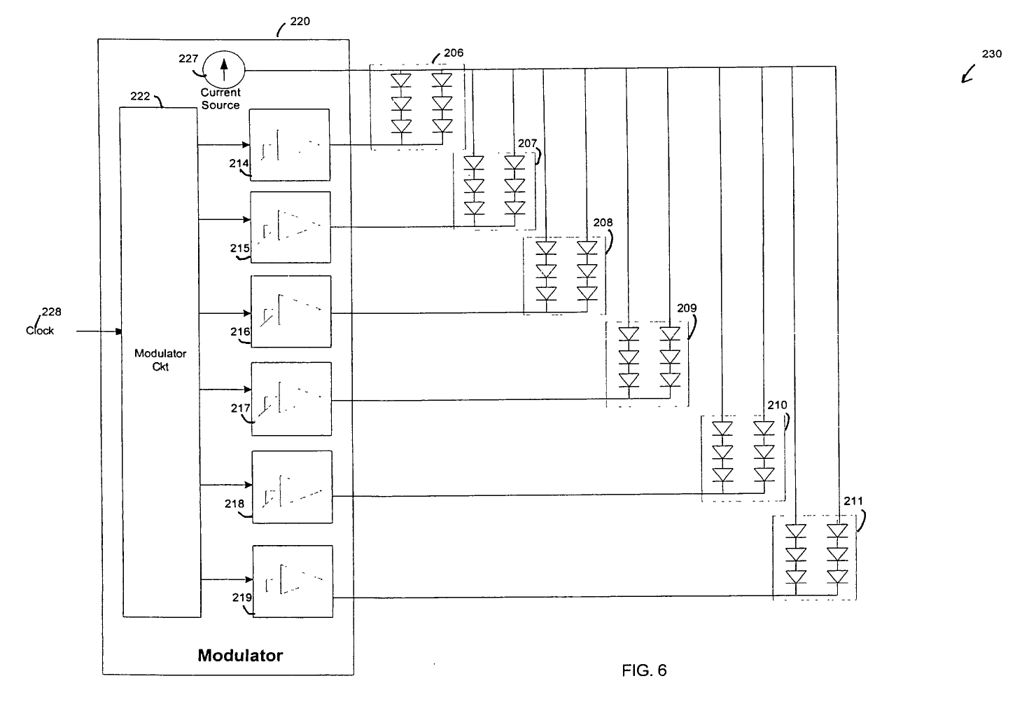

In the illustrated example, cycling power to the LED(s) 202 is accomplished through use of a modulator. Referring to FIG. 5, in addition to the LED stick 203, the backlight assembly 200 includes a modulator 220 for modulating current through the LEDs 202. The modulator 220 includes a modulator circuit 222, a number of sink buffers 214, 219, a brightness control 226, a current source 227, a clock 228, and a voltage source 229. As is shown in FIG. 5, each LED string is electrically coupled to a sink buffer and the current source 227. For example, the LED string 204 is electrically coupled to the sink buffer 219 via a sink buffer connector. The sink buffers 214, 219 may be implemented by any suitable sink buffers. For example, they may be implemented by NPN Darlington transistors sold under the trade name 62002 by Toshiba, Inc. The current source may be any suitable current source configured to generate sufficient current to drive the LEDs such as MAX1698 manufactured by MAXIM, Inc. Although not shown, a resistor may also be included between the individual LED strings 206-211 (see FIG. 6) and their corresponding sink buffer 214-219 (see FIG. 6) to adjust the current through the LED strings 206-211. Moreover, the modulator 220 may be manufactured as a separate card (e.g., an inverter card replacement) or be included in an existing notebook chipset.

More than one LED string may be electrically coupled to one sink buffer 214-219 to control the illumination time periods of the LEDs associated with that particular sink buffer 214-219. Such an arrangement may be referred to as an LED bank. For example, FIG. 5 shows an LED bank 206 including two LED strings—a total of six LEDs—electrically coupled to the sink buffer 214. Using this approach, in the example of FIG. 6, thirty-six LED(s) 202 used in a large form factor screen are configured into six LED banks 206-211 having six LEDs each, with each LED bank electrically coupled to an individual sink buffer 214-219. The LED banks 206-211 may also be configured with more or less LEDs, depending on the illumination requirements of the flat panel display. As discussed below, the LEDs of the various LED banks 206, 207, 208, 209, 210, 211 shown in the example of FIG. 6 are physically interleaved to permit cycling illumination of the LED banks 206-211 while providing a substantially even backlight illumination to the flat panel display 22.

The current source 227 is constructed to provide current through the LED(s) 202 when a current path is established from the voltage source 219 to a ground voltage. The sink buffers 214-219 operate in response to pulse waves (referred to herein as “modulation signals”) generated by the modulator circuit 222 to pulse, or periodically establish the current flow through selected LED bank 206-211. For example, a periodic modulation signal generated by the modulator circuit 222 causes the sink buffer 214 to periodically establish current flow through the LED bank 206. The modulation signal may be a periodic square wave or a rectangular wave having periodic low voltage portions and periodic high voltage portions to modulate the current flow through the LED banks 206-211 at a preselected frequency.

Each LED bank 206-211 cycles on and off in response to the high and low voltage portions of the modulation signal received by its associated sink buffer 214-219. The sink buffers 214-219 may be configured to respond to the high and low voltage portions of a modulation signal in any number of ways. For example, in one configuration, the sink buffers 214-219 are implemented as NPN transistors which turn on and off in response to the modulation signal. When a periodic modulation signal is received at the base of the NPN transistor implementing a sink buffer 214-219 as a high voltage, the transistor 214-219 switches on to thereby connect its corresponding LED bank 206-211 to ground, resulting in a current flow through the subject LEDs. In other words, upon receipt of the high voltage portion of the periodic modulation signal, the sink buffer 214-219 operates to sink current from the current source 227 to ground, thereby causing the LEDs in the corresponding LED bank 206-211 to illuminate. Conversely, when a periodic modulation signal is received at the base of the NPN transistor implementing a sink buffer 214-219 as a low voltage, that transistor 214-219 turns off to thereby isolate the corresponding LED bank 206-211 from ground, resulting in no current flow through that LED bank 206-211. For example, upon receipt of the low voltage portion of the periodic modulation signal, the sink buffer 214 prevents the current from reaching ground, thereby disabling the LEDs in LED bank 206 from illuminating. Thus, the transistor switches implementing the sink buffers 214-219 respond to the periodic modulation signal by controlling the luminous output of the LED(s) 202 in the corresponding LED banks 206-211. As will be appreciated by those of ordinary skill in the art, the sink buffer 214-219 may be implemented in any number of ways including using FETs or PNP transistors.

The luminous output of the LED(s) 202 may be adjusted within a predetermined range via the brightness control 226 operatively coupled to the current source 227. Of course, the predetermined range is selected to allow only slight variations in the luminous outputs of the LED(s) 202. The brightness control 226 may be implemented by any suitable control device configured to increase or decrease current output by the current source 227 upon a manual adjustment to the brightness control 226. For example, the brightness control 226 may be implemented by a notebook chipset that provides a pulse width modulation signal sold under 82815 by Intel Corporation.

By properly timing the cycling of the current through the individual LEDs 202, a suitable overall luminous output is maintained by the backlight assembly 200. To achieve the proper balance between LED illumination and non-illumination, a variety of modulation schemes can be utilized by the modulator 220.

Although the modulation schemes may vary in a number of ways, they typically include cycling the LEDs between an illuminating state and a non-illuminating state. Generally, modulating the LED(s) 202 using a duty cycle greater than 50% (i.e., current passing through the LED(s) 202 more than 50% of the time) will produce sufficient illumination. However, in the illustrated example, the duty cycle is between 60-80% at a relatively low frequency (e.g., 60-200 hertz (Hz)) in order to optimize the life span and brightness of the LED(s) 202.

Staggering the timing of current flow through the individual LED banks 206-211 maintains a suitable overall luminous output by the backlight assembly 200. Staggering the timing of current flow through the individual LED banks 206-211 can be accomplished by driving the individual sink buffers 214-219, and, therefore, their associated LED banks 206-211, with identical periodic rectangular modulation signals that are offset in time (i.e., have different phases). For example, if a periodic modulation signal having a duty cycle of 60% is received by the sink buffer 214, the six LEDs 206 associated with the sink buffer 214 are all substantially simultaneously in the on state 60% of the time and all substantially simultaneously in the off state 40% of the time. If the identical periodic rectangular modulation signal is received by the sink buffer 219, time offset by a predetermined amount, the LEDs 211 associated with the sink buffer 219 are all substantially simultaneously in the on state 60% of the time and all substantially simultaneously in the off state 40% of the time. The time periods in which the LED banks 206-211 associated with the various sink buffers 214-219 are in the on state are offset from the time periods in which the LED banks 206-211 associated with each of the other sink buffers 214-219 are in the on state. In this way, the illumination time periods of each of the LED banks 206-211 are staggered to ensure that suitable luminous output is produced by the backlight assembly 200 while maintaining the temperatures of the LEDs at a level that lengthens their useful life.

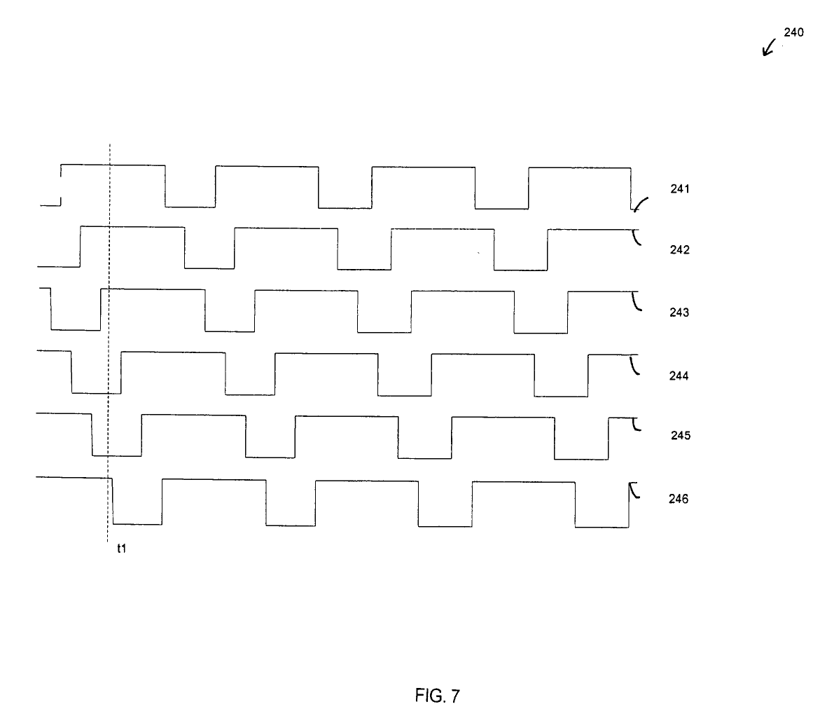

FIG. 7 is an example modulation scheme 240 that may be generated by the modulation circuit 222 of the backlight assembly 200. Six identical modulation signals 241-246 having a duty cycle of about 66%, and offset in time by a predetermined amount with respect to one another, are shown. As previously mentioned in connection with FIG. 5, the modulator circuit 222 responds to a signal from the clock 228 by generating the modulation signals 241-246. Those signals are respectively received by the individual sink buffers 214-219 of the backlight assembly 200.

Referring to FIG. 7, each of the modulation signals 241-246 drives an individual sink buffer 214-219 to control illumination of an individual LED bank 206-211. In the example modulation scheme 240, the LED banks 206-211 are illuminated at times when their associated sink buffers 214-219 receive a high signal (based on an NPN sink buffer). For example, at a time t₁, the LED banks 209, 210 associated with sink buffers 217, 218 receiving the modulation signals 244 and 245 are not illuminated, while the LED banks 206-208 and 211 associated with the sink buffers 214-216 and 219 receiving the modulation signals 241, 242, 243, and 246 respectively, are illuminated. Accordingly, in the case of an LED stick having thirty-six LEDs configured as six LED banks 206-211 of six LEDs per bank, twelve LED(s) 202 would not be illuminated and 24 LED(s) 202 would be illuminated at the time t₁ shown in FIG. 7

As will be appreciated by those of ordinary skill in the art, the modulation scheme to modulate the LEDs of the backlight assembly 200 may be constructed in any number of ways to ensure sufficient LED brightness while preventing LED overheating. For example, the modulation scheme may include varying the duty cycle, varying the frequency, varying the phase, and/or varying the shape of the modulation signals described above, etc.

FIG. 8 is an illustration of an example configuration 250 for the backlight assembly 200. The example configuration 250 includes the LED stick 203 having the six LED banks 206-211, although only the LED banks 206 and 207 are labeled and discussed in detail. As shown, each LED bank 206-211 includes six LEDs for a total of thirty-six LEDs in thirty-six positions, arranged in a linear fashion. The example configuration 250 also includes the modulator 220, the six sink buffers 214-219 electrically coupled to the six LED banks 206-211 of the LED stick 203 via six sink buffer connectors 281-286. Power to the example backlight assembly 250 is provided by a 12 V source voltage 256 via an electrical connector 260.

In order to achieve uniform brightness when illuminated, the six LEDs per LED bank 206-211 occupy every sixth position in the LED stick 203. For example, the first LED in the LED bank 206 occupies the leftmost position in FIG. 8, (i.e., the first position 262). The second LED in the LED bank 206 occupies the seventh position 264, the third LED occupies the thirteenth position 266, and so on with the sixth LED in the LED bank 206 occupying the thirtieth position 268. Similarly, the first LED in the LED bank 207 occupies the second position 270, the second LED in the LED bank 207 occupies the eighth position 272, the third LED in the LED bank 207 occupies the fourteenth position 274 and so on with the sixth LED of the LED bank 207 occupying the thirty-first position 276. Although not labeled, the remaining 24 LED positions are occupied by LEDs in the remaining four LED banks 208-211 in the same pattern as explained above with respect to the first two LED banks 206 and 207.

In addition, each LED 202 in the LED stick 203 is positioned equidistant from its neighbor LED. The distance between the LED(s) 202 is determined by a number of factors including the size of the flat panel display to be illuminated, the illumination required, the size of the LED(s) 202 selected for the backlight assembly, etc. For example, for a 13 inch flat panel display requiring thirty-six LEDs, the LEDs are spaced 4 mm apart yielding a 205 mm LED stick.

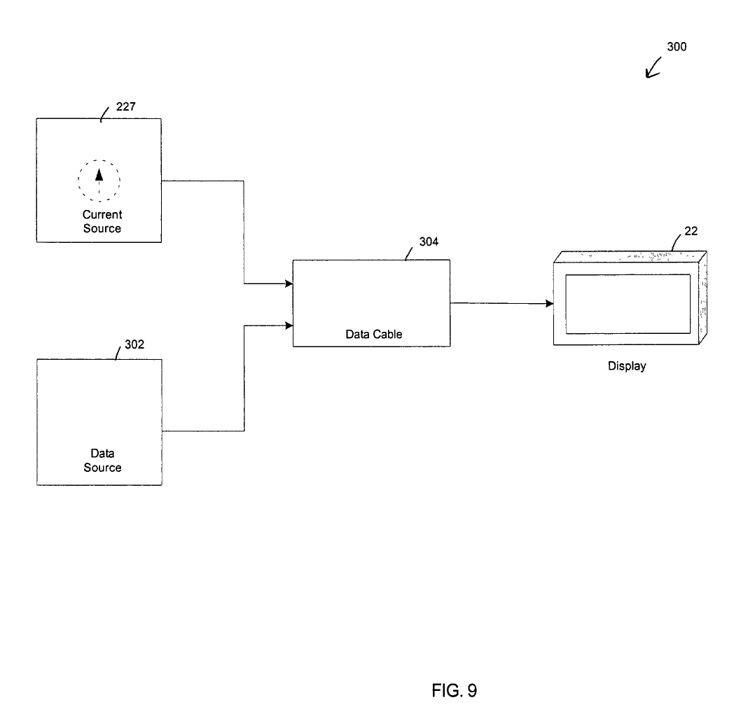

Because of the low power needs of the backlight assembly of FIGS. 5-8, power can be delivered to the backlight through a data cable. FIG. 9 is a block diagram of an example data cable configuration 300 for the backlight assembly 200. As previously mentioned in connection with FIGS. 5 and 6, the current source 227 provides current through the LED banks 206-211 to illuminate the flat panel display 22 when a current path is established via operation of the sink buffers 214-219, respectively. The current is delivered to the LED banks 206-211 via a data cable 304. Similarly, a data source, for example, a central processing unit (CPU) causes data to be delivered to the flat panel display 22 via that same data cable 304.

In summary, persons of ordinary skill in the art will readily appreciate that an apparatus for backlighting a flat panel display has been provided. Systems using the example apparatus and methods described herein may benefit from reduced power requirements. In addition to reducing power requirements, systems using the example apparatus and methods described herein may benefit from streamlined manufacturing processes by replacing the inverters currently used in traditional flat panel displays with digital modulators that can be integrated into current chipsets.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A backlight assembly for a monitor comprising:
a modulator; and
a plurality of white light emitting diodes coupled to the modulator, the white light emitting diodes comprising blue light emitting diodes coated with phosphors.

2. A backlight assembly as defined in claim 1 wherein the modulator comprises:
a current source coupled to the plurality of white light emitting diodes;
a plurality of sink buffers, each of the sink buffers being coupled to a respective subset of the plurality of white light emitting diodes and being configured to respond to a modulation signal to establish a current path; and
a modulator circuit to supply modulation signals to the sink buffers.

3. A backlight assembly as defined in claim 2 wherein the light emitting diodes are illuminated for a first time period, and not illuminated for a second time period, and the first time period is greater than the second time period.

4. A backlight assembly as defined in claim 2 wherein each of the modulation signals comprise a periodic wave having a duty cycle between about fifty percent and about eighty percent, and having a frequency between about 60 Hertz and about 200 Hertz.

5. A backlight assembly as defined in claim 2 wherein each of the subsets of the plurality of white light emitting diodes comprises an equal number of white light emitting diodes.

6. A backlight assembly as defined in claim 1 further comprising a large form factor display.

7. A backlight assembly as defined in claim 1 further comprising a thin film transistor liquid crystal display screen.

8. A backlight assembly as defined in claim 1 wherein the plurality of white light emitting diodes comprises a white light emitting diode stick.

9. A display device comprising:
a display screen;
a light source to provide light to the display screen and including a plurality of light emitting diodes; and
a drive circuit to illuminate a first subset of the light emitting diodes for a first time period and to illuminate a second subset of the light emitting diodes for a second time period.

10. A display device as defined in claim 8 wherein the first and second time periods partially overlap.

11. A display device comprising:
a display screen;
a first bank of light emitting diodes to deliver light to the display screen;
a second bank of light emitting diodes to deliver light to the display screen; and
a drive circuit to illuminate the first bank for a first time period and the second bank for a second time period partially overlapping with the first time period.

12. A display device as defined in claim 11 wherein the drive circuit comprises:
a current source coupled to the first and second banks of light emitting diodes;
a first sink buffer coupled to the first bank, the first sink buffer being configured to respond to a first modulation signal to establish a first current path;
a second sink buffer coupled to the second bank, the second sink buffer being configured to respond to a second modulation signal to establish a second current path; and
a modulator circuit to supply modulation signals to the first and second sink buffers.

13. A display device comprising:
a display screen;
a first bank of light emitting diodes to deliver light to the display screen;
a second bank of light emitting diodes to deliver light to the display screen, the second bank of light emitting diodes being physically interleaved with the first plurality of diodes to provide a substantially continuous illumination to the display screen; and
a drive circuit to illuminate the first bank for a first time period and the second bank for a second time period partially overlapping with the first time period.

14. A display device as defined in claim 13 wherein the display screen is a large form factor display.

15. A display device as defined in claim 13 wherein the first and second time periods are determined by a periodic wave having a duty cycle between about fifty percent and about eighty percent, and having a frequency between about 60 Hertz and about 200 Hertz.

16. A method of providing light to a display screen comprising:
(a) illuminating a first bank of light emitting diodes for a first time period; and
(b) illuminating a second bank of light emitting diodes for a second time period partially overlapping with the first time period.

17. A method as defined in claim 16 further comprising periodically repeating (a) and (b).

18. A method as defined in claim 16 wherein the first and second time periods are determined by a periodic wave having a duty cycle between about fifty percent and about eighty percent, and having a frequency between about 60 Hertz and about 200 Hertz.

19. For use with a desktop computer, a flat panel display comprising:
a display screen;
a first bank of light emitting diodes to deliver light to the display screen;
a second bank of light emitting diodes to deliver light to the display screen;
a drive circuit to illuminate the first bank for a first time period and the second bank for a second time period; and
a data cable to deliver data for display on the display screen and power to illuminate the first and second banks.

20. A flat panel display as defined in claim 19 wherein the drive circuit comprises:
a current source coupled to the first and second banks of light emitting diodes;
a first sink buffer coupled to the first bank, the first sink buffer being configured to respond to a first modulation signal to establish a first current path;
a second sink buffer coupled to the second bank, the second sink buffer being configured to respond to a second modulation signal to establish a second current path; and
a modulator circuit to supply modulation signals to the first and second sink buffers.

21. A flat panel display as defined in claim 20 wherein the first and second modulation signals comprise a periodic wave having a duty cycle between about fifty percent and about eighty percent, and having a frequency between about 60 Hertz and about 200 Hertz.

22. A flat panel display as defined in claim 19 wherein the display screen is a large form factor display.

23. A flat panel display as defined in claim 19 wherein the display screen is a thin film transistor liquid crystal display screen.

24. A flat panel display as defined in claim 19 wherein the first and second bank of light emitting diodes comprise a white light emitting diode stick.

25. A computer comprising:
a housing;
an input device;
an output device;
a display screen;
a processor coupled to the input device, the output device, and the display screen; and
a backlight assembly to provide light to the display screen, the backlight assembly comprising a plurality of light emitting diodes driven to generate the light.

26. A computer as defined in claim 25 wherein the housing is a laptop housing.

27. A computer as defined in claim 25 wherein the housing is a desktop housing.
